(19) United States
(12) Patent Application Publication
(10) Pub. No.: US 2011/0085538 A1
(43) Pub. Date: Apr. 14, 2011

(54) SYSTEM AND METHOD FOR OPERATING A DEVICE OVER MULTIPLE FREQUENCY BANDS

(75) Inventor: Paul Feinberg, River Vale, NJ (US)

(73) Assignees: SONY CORPORATION, Tokyo (JP); SONY ELECTRONICS INC., Park Ridge, NJ (US)

(21) Appl. No.: 12/575,722

(22) Filed: Oct. 8, 2009

(51) Int. Cl. H04J 1/00; H04B 17/00

(52) U.S. Cl. 370/343; 455/62

(57) ABSTRACT

A method for enabling a device executing a processing module to enable simultaneous operations in multiple frequency bands. The method includes sensing a set of one or more vacant channels, determining availability of particular spectrum channels in the one or more vacant channels, reserving one or more particular spectrum channels from the one or more vacant channels and configuring the device for the one or more particular spectrum channels for communication.

### BACKGROUND

1. Field of the Invention

Embodiments of the present invention generally relate to communication systems and, more particularly, to a method and apparatus for enabling a device to operate over multiple frequency bands.

2. Description of the Related Art

As wireless technology has become cheap and ubiquitous, demand for portions of the frequency spectrum has steadily increased. Wireless networks are evolving to provide a variety of data services, including interactive, real-time, and delay-sensitive applications, such as Voice over Internet Protocol (VolP), video conferencing, mobile gaming, mobile music, high-speed file transfers and/or the like.

Generally, a range of frequencies lying within a radio frequency (RF) spectrum is utilized for the broadband communication. The spectrum is divided into various sections of frequencies called as bands. Typically, the various bands within the radio frequency spectrum are regulated by the government of the particular country and distributed to various service providers for various applications, such as cellular system, television and/or the like. For example, in a cellular system, a regulatory body typically licenses a frequency spectrum for a corresponding geographic area (service area) that is used by a licensed system operator to provide wireless service within that service area. Based upon the licensed spectrum and the operating standards employed for the service area, the system operator deploys a plurality of carrier frequencies (channels) within the frequency spectrum that support the subscriber units within the service area.

Regardless of what type of communication method or technology is employed, the radio frequency (RF) spectrum that a device may use to communicate is becoming more and more crowded. Further, there is a need for a more efficient allocation of radio resources to support different types of users whose bandwidth requirements can vary substantially. Increasingly, wireless users want access to a diverse set of data and multimedia applications with different bandwidth demands, as well as to real-time applications (such as gaming and video) where minimum performance guarantees are required in terms of bandwidth, delay, and bit error rate.

Conventionally, there exist various techniques that enable frequency agility in radios as well as flexibility in choice of communication modes. In conventional techniques, if one frequency band is not available, these techniques help the device to adapt to and occupy another frequency spectrum. However, such techniques require a significant portion of contiguous spectrum. Moreover, the allocation of the fixed contiguous spectrum to the various users wastes a particular frequency band that is not in use at a particular time in case of minimal bandwidth usage. To overcome above limitations, various other techniques have been developed, which do not require the contiguous spectrum and instead provide a non-contiguous spectrum to the users. However, in case of transmission of high volume data, even a particular non-contiguous frequency band may be insufficient.

Therefore, there exists a need in the art for a method and apparatus for enabling a device to operate over multiple frequency bands.

### SUMMARY OF THE INVENTION

Embodiments of the present disclosure generally include a method and apparatus for enabling a device for simultaneous operations in multiple frequency bands. In one embodiment, the method is performed by a device executing a processing module for enabling simultaneous operations in multiple frequency bands. The method includes sensing a set of one or more vacant channels, determining availability of particular spectrum channels in the one or more vacant channels, reserving one or more particular spectrum channels from the one or more vacant channels and configuring the device for the one or more particular spectrum channels for communication.

In another embodiment, the device capable of simultaneous operations in multiple frequency bands includes a sensor for sensing a set of one or more vacant channels, a processing module for determining availability of particular spectrum channels in the one or more vacant channels for broadband communication, a communication module for reserving one or more particular spectrum channels and a configuration module for reprogramming the device for the one or more particular spectrum channels for communication.

In yet another embodiment, the device capable of simultaneous operations in multiple frequency bands includes means for sensing one or more vacant channels, means for determining availability of particular spectrum in the one or more vacant channels for broadband communication, means for reserving one or more particular spectrum channels, and means for reprogramming the device for the one or more particular spectrum channels for communication.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates channel partitions in a radio frequency (RF) spectrum, according to one or more embodiments of the present invention;

FIG. 2 is a block diagram of a device capable of simultaneous operations in multiple frequency bands, according to one or more embodiments of the present invention;

FIG. 3 illustrates a functional diagram of a system capable of simultaneous operations in multiple frequency bands according to one or more embodiments of the present invention; and

FIG. 4 is a flow diagram of a method for simultaneous operations in multiple frequency bands according to one or more embodiments of the present invention.

### DETAILED DESCRIPTION

As explained further below, various embodiments of the invention disclose a method and device for simultaneous operations in multiple frequency bands. The device comprises a sensor, a processing module, a communication module and a configuration module. In the present invention, one or more vacant channels or whitespace within a radio frequency (RF) spectrum are recognized. After sensing the one or more vacant channels, one or more sufficient spectrum channels that are available within the one or more vacant channels are determined. Thereafter, data from a first device is communicated over the one or more sufficient spectrum channels to a second device.

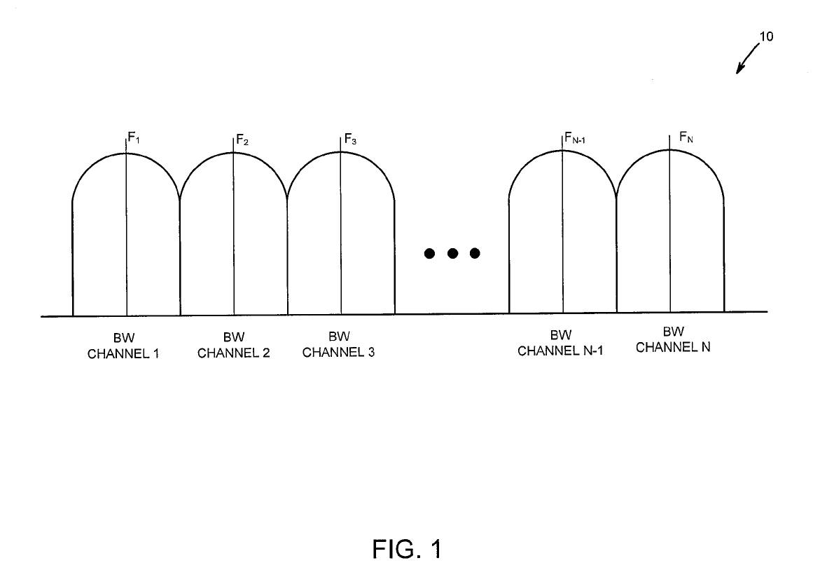

FIG. 1 illustrates channel partitions in the radio frequency spectrum, according to one or more embodiments of the present invention. The RF spectrum includes a range of radio frequencies that defines allowable or usable channels for specific radio transmission technologies. The range of frequencies classified as the RF spectrum is a part of the overall electromagnetic spectrum. Further, the RF spectrum is lower in frequency than Infrared spectrum or visible frequencies.

Generally, the RF spectrum is divided arbitrarily into a number of bands from very low frequencies to super frequencies. The RF spectrum is typically government regulated in most developed countries and in some cases sold or licensed to operators of private radio transmission systems (e.g. Cellular telephone operators or Broadcast Television Stations). Sections of the RF spectrum are allocated to various users, such as telegraph, telephonic speech, telemetry, radio, television broadcasting and/or the like. For example, in the United States, the FCC (Federal Communications Commission) designates licensees for the various frequencies for particular purposes. For example, all FM radio stations transmit in a band of frequencies between 88 megahertz and 108 megahertz. This band of the RF spectrum is used for no other purpose but FM radio broadcasts. However, utilization of the frequency bands or channels varies with time and geographic location. As a result, one or more frequency bands may remain unutilized at a particular time. Therefore, a method or a system is required to optimally utilize the frequency bands so as to satisfy the demands of increasing users, which one of the features of the present invention.

Traditionally, an allocated frequency band is divided into channels of equal bandwidth (BW) to allow efficient use of the spectrum, as illustrated generally at 10 in the FIG. 1. Further, a signal may occupy only one channel with center frequency, fₓ, at one time, as illustrated by f₁, f₂, f₃ . . . f_{N-1}, f_{N}, as assigned by a system controller. The choice of the bandwidth for each channel is pertinent to the requirements of an individual user.

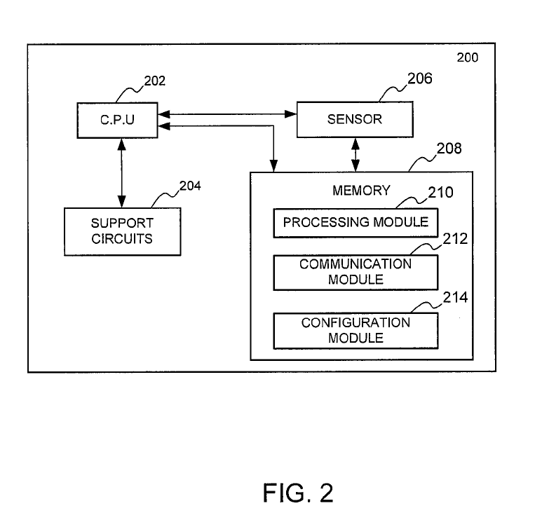

FIG. 2 is a block diagram of a device 200 capable of simultaneous operations in multiple frequency bands, according to one or more embodiments of the present invention.

The device 200 is a type of computing device (e.g., a pocket-sized computer, a laptop, a desktop, a Personal Digital Assistant (PDA), a mobile phone, radio and/or the like), a personal computer memory card international association (PCMCIA) card or PC card, a cellular telephone, a personal information manager (PIM), a wireless access point (WAP), a base station, a base station transceiver, a microelectronic circuit, a circuit board and/or the like known to one of ordinary skill in the art having the benefit of this disclosure. The device 200 includes a Central Processing Unit (CPU) 202, various support circuits 204, a sensor 206 and a memory 208.

The CPU 202 may comprise one or more commercially available microprocessors or microcontrollers that facilitate data processing and storage. The various support circuits 204 facilitate an operation of the CPU 202 and may include one or more clock circuits, power supplies, cache, input/output circuits and the like. The memory 208 comprises at least one of Read Only Memory (ROM), Random Access Memory (RAM), disk drive storage, optical storage, removable storage and the like. The memory 208 includes various software packages, such as a processing module 210, a communication module 212 and a configuration module 214. The memory 208 may further include various data (not shown in FIG. 2).

The sensor 206 is configured to sense one or more vacant channels within the radio frequency spectrum. Generally, various allocated frequency bands of the radio frequency spectrum are utilized based on time and location. Under the current regulatory regime, many frequency bands in the broadcast RF spectrum are under-utilized. Further, one more frequency bands or channels remain vacant i.e., unutilized at a particular time due to limited usage of the channel by the users. Consequently, the one or more vacant channels can be utilized for other needful users. In one embodiment, the sensor 206 searches for the one or more vacant channels within the RF spectrum at a particular time.

In an alternate embodiment of the present invention, the sensor 206 selects a combination of bands, frequency channels and communication modes that is optimal for a specific application. The application may consist of a user browsing the web using http/tcp/hip protocols, user talking on a voice call, involved in a file transfer, such as music download and/or the like. After selecting an optimal combination, the sensor 206 searches for that particular frequency band. For example, if a specific application requires one or more bands within spectrum of a cellular, then the sensor 206 senses for the one or more vacant channels in that band only.

In an embodiment of the present invention, the sensor 206 sends a beacon signal in a commonly used band i.e., a beacon band. The beacon band may be utilized for discussing about the frequencies that are occupied or reserved at a particular moment. Further, information regarding the occupied frequencies transmitted on the beacon band is then utilized to determine where the one or more vacant channels exist in the RF spectrum.

According to one embodiment of the present invention, the beacon signal may include information regarding the device 200. Further, the beacon signal may include, but is not limited to information related to type of network services offered, a list of frequency bands that the device 200 has found to be unoccupied, data rates available for high and low data rate communications, modulation techniques used for high and low data rate communications and/or the like. In addition, the beacon signal may also provide a wide spectrum of additional functional capabilities, such as a timing channel, a ranging channel, a power conservation function for mobile devices with limited power reserve, a dynamic node-to-node power transmit/receive power control function, a network status/health/control status provider and/or the like.

The processing module 210 is configured to determine availability of sufficient spectrum channels in the one or more vacant channels or the whitespace. In one embodiment, the processing module 210 determines whether the one or more vacant channels as sensed by the sensor 206 are sufficient to transfer data for a particular application. In other words, the sensor 206 determines available spectrum channels in the one or more vacant channels that would be sufficient for communicating the data of the device 200. In another embodiment, the processing module 210 communicates with the beacon signal to find whether one or more other devices are winding for the same vacant channels as required by the device 200.

In general, the band that is commonly considered for whitespace is the TV band. Typically, a broadcast television transmission is in the tens of kilo-watts, with some stations exceeding a hundred kilo-watts of transmitted power. Thus, the transmitted signal can travel for tens, and sometimes a hundred or more miles. To avoid interference between two or more TV broadcasts at the same frequency, each carrying different viewing contents, the FCC partitions use of specific radio frequency (RF) bands to specific geographic regions. Therefore, each geographic area has RF bands that are not used. There are typically a number of television channels in a given geographic area that are not used, because transmission may cause interference to co-channel (i.e. same RF band) or adjacent channel stations.

In an alternate embodiment of the present invention, the processing module 210 may utilize, but not limited to various methods for determining availability of the vacant channels. The processing module 210 may utilize collision detection listening, or table look up methods in case of TV bands. In another embodiment, the processing module 210 may utilize base station negotiation method such as in the case of the cellular band. For example, in case of the TV band the sensor 206 listens for any kind of signal that normally operates in that band. As another example, the sensor 206 may comprise a connection for performing a table lookup of a centralized database, accessed through the Internet. The table provides information as to whether various portions of the spectrum are in use depending upon the geographical location. As another example, the sensor 206 may interface with a cellular base station or tower in case of the cellular band. Further, the base station negotiation may be performed over a particular common channel.

According to various embodiments of the present invention, the processing module 210 processes the beacon signal to negotiate for the availability of the one or more vacant channels if the sufficient spectrum channels are available. Further, the processing module 210 transmits information regarding time-period for which a particular channel is required, need level that would identify the application type, whether it is video, whether it is data transfer and priority level. Thereafter, some kind of handshaking takes place within the beacon band where the processing module 210 negotiates for the vacant channels and then the processing module 210 determines which device would occupy the channel.

In an embodiment, the negotiation is performed with one or more owners of the vacant channels as well as with the one or more devices that are winding for the channels. For example, if a device A and a device B, both find the same vacant channel and both the devices require the same channel for the respective applications, then both the devices negotiate within the beacon band for the vacant channels with each other as well as with the respective owners of the channels. In another embodiment, the device 200 starts listening for other available vacant channel if the processing module 210 of the device 200 can't negotiate with another device.

In an embodiment of the present invention, the priority level may be based on a traffic type. For example, one or more devices that communicate a certain type of traffic, such as video, may have a higher priority entitlement to the frequency band, over devices that communicate another type of traffic, such as voice or audio. In another embodiment, the priority level could also be based on communication protocol. Further, regardless of the basis for prioritization, if a conflict regarding access to or use of the frequency band arises between any two devices, the higher priority device will prevail. In one embodiment, if there is a conflict between devices having the same priority, one device may receive priority for a certain period of time, then switch priority to the other device. In another embodiment, the devices may negotiate usage based on a first-come, first-serve basis. This priority level information is provided by the processing module 210 through the beacon signal within the beacon band and may be updated from time-to-time across all participant devices.

The communication module 212 is configured to reserve the one or more sufficient spectrum channels. After a particular portion of the spectrum is negotiated, the communication module 212 reserves those channels. In one embodiment, the communication module 212 reserves the available channels in order to avoid other devices that occupy the one or more sufficient spectrum channels. In another embodiment, the communication module 212 communicates with the configuration module 214 to transmit the data over the one or more sufficient spectrum channels to another device at a receiver end. The communication module 212 modulates each data packet with an appropriate radio frequency and transmits each modulated data packet simultaneously through antenna or through any other means (not shown in the Figure) for broadband communication.

The configuration module 214 reprograms the device 200 for the one or more sufficient spectrum channels for communication. In one embodiment, the configuration module 214 configures the device 200 so that the device 200 can transmit the data over the one or more sufficient spectrum channels simultaneously. In another embodiment, the configuration module 214 segments the data in to one or more packets. The configuration module 214 provides a header to indicate sequence number for each packet. For example, if the data is segmented into four packets i.e., A, B, C, D and arranged in the sequence of ABCD within the data, then the configuration module 214 provides a header for each of the packets to indicate the order of sequence of the packets within the data. In another embodiment, the configuration module 214 configures each data packet so that each packet can be modulated over different radio frequency waveforms. In yet another embodiment, the configuration module 214 may utilize the Medium Access Control (MAC) protocols to coordinate usage of the multiple frequency bands simultaneously.

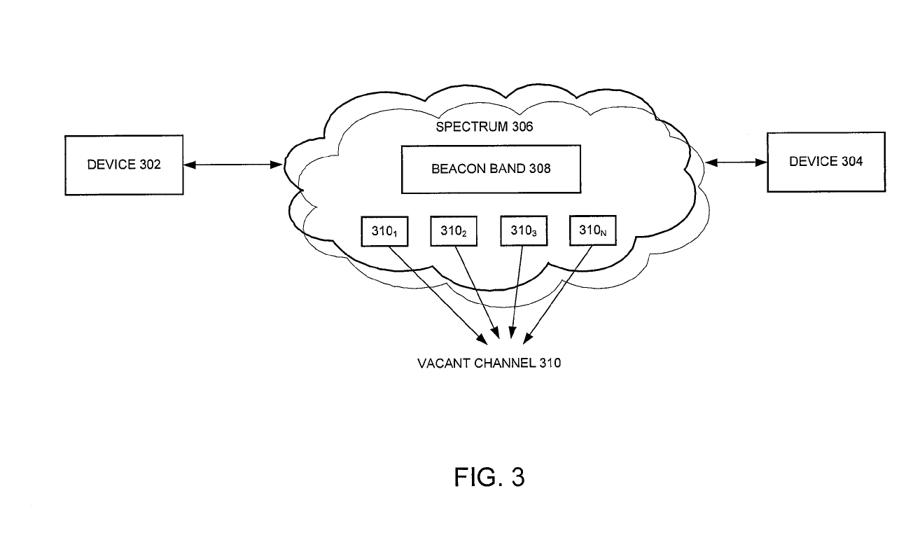

FIG. 3 illustrates a functional diagram of the system 300 capable of simultaneous operations in multiple frequency bands according to one or more embodiments of the present invention. For providing services for various applications, such as for internet browsing (TCP/IP), voice communication, images, short message service (SMS); and multimedia service (MMS) and/or the like, one or more spectrum channels are required to transmit high volume data over the multiple frequency band simultaneously.

The system 300 includes a first device 302, a second device 304 and a radio frequency spectrum 306. The first device 302 (e.g., a device 200 as depicted in FIG. 2) functions as a transmitter to transmit data over the radio frequency spectrum 306. The second device 304 (e.g., another device 200 as depicted in FIG. 2) functions as a receiver to receive the data transmitted by the first device 302. The radio frequency spectrum 306 includes a beacon band 308, occupied channels (not shown in the Figure) and one or more vacant channels 310₁ . . . 310_{N}.

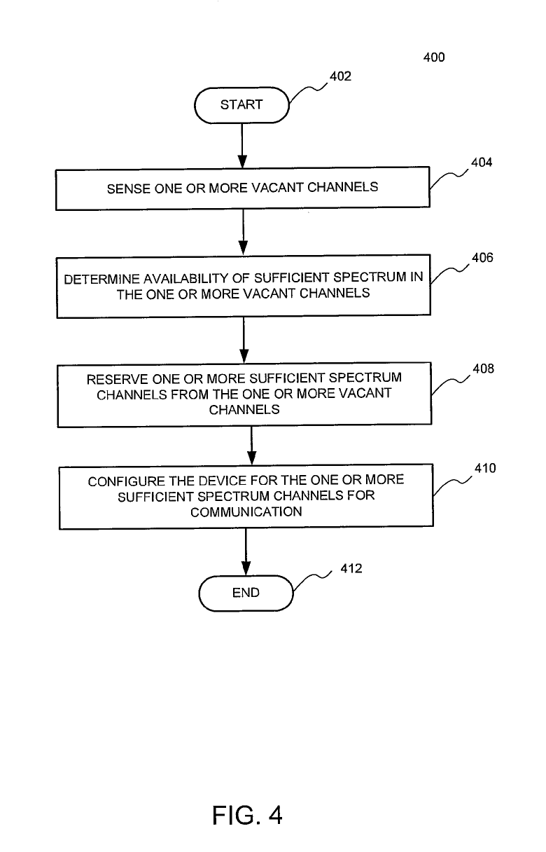

In one embodiment, the first device 302 periodically sends a beacon signal within the beacon band 308 to determine if the one or more vacant channels required for transmitting the data are available within the RF spectrum 306. In another embodiment, the first device 302 may listen to determine the available vacant channels. The first device 302 may then tune to one or more of the available vacant channels. If the channel is occupied, the first device 302 moves on to the next available channel. Once the first device 302 finds an unoccupied or unused channel, the first device 302 negotiates with other devices for use of the channel. The negotiation step is discussed further with respect to FIG. 4. After negotiating for the channels, the first device 302 transmits one or more packets of the data over the one or more available sufficient spectrum channels or vacant channels 310 simultaneously. In one embodiment, the second device 304 recognizes which spectrum channels have been negotiated and receives each of the packets of the data over those channels. In one embodiment, the second device 304 reconstructs the data by recombining the packets in sequence order as communicated by the device 302.

FIG. 4 is a flow diagram of a method 400 for simultaneous operations in multiple frequency bands according to one or more embodiments of the present invention. The method 400 starts at step 402 and proceed to step 404. At step 404, one or more vacant channels are sensed. In one embodiment, a sensor (e.g., the sensor 206 of FIG. 2) senses the one or more vacant channels. The step 404 proceeds to step 406, at which availability of sufficient spectrum channels in the one or more vacant channels is determined. In one embodiment, a processing module (e.g., the processing module 210 of the FIG. 2) determines the availability of sufficient spectrum channels in the one or more vacant channels for broadband communication.

At step 408, one or more sufficient spectrum channels from the one or more vacant channels are reserved. In one embodiment, a communication module (e.g., the communication module 212 of FIG. 2) reserves the one or more sufficient spectrum channels. The step 408 proceeds to step 410, at which a device is configured for the one or more sufficient spectrum channels for the communication. In one embodiment, a configuration module (e.g., the configuration module 214 of FIG. 2) reprograms or reconfigures a device (e.g., the device 200 of FIG. 2) for the one or more sufficient spectrum channels for communication. As part of the configuration step, the device 200 informs a receiver of the spectrum bands the communication will occur over. This may be performed by using the beacon band 308 to send instructions to the receiver to listen on particular portions of the spectrum. In another embodiment, a separate portion of the spectrum may be designated to transmit configuration information to properly configured devices. At step 412, the method 400 ends with both sender and receiver configured to transmit and receive on the designated whitespace bands.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A method performed by a device programmed by a processing module for enabling a device for simultaneous operations in multiple frequency bands comprising:
sensing one or more vacant channels;
determining availability of a set of spectrum channels in the one or more vacant channels;
reserving one or more particular spectrum channels from the one or more vacant channels; and
configuring the device to use the one or more particular spectrum channels for communication.

2. The method of claim 1 further comprising choosing an optimal combination of one or more of bands, frequency channels, and communication modes for the broadband communication.

3. The method of claim 1, wherein reserving the one or more sufficient spectrum channels enables avoiding other devices to occupy the one or more sufficient spectrum channels.

4. The method of claim 1 further comprising minimizing self interference of the device during operation in the multiple frequency bands.

5. The method of claim 1, wherein the one or more vacant channels comprises white space spectrum.

6. The method of claim 1, wherein the device includes at least one member of a group comprising: a computing device, a portable computing device, a desktop computer, a laptop computer, a palm sized computer, a pocket-sized computer, a personal computer memory card international association (PCMCIA) card or PC card, a cellular telephone, a personal data assistant (PDA), a personal information manager (PIM), a wireless access point (WAP), a base station, a base station transceiver, a microelectronic circuit, and a circuit board.

7. The method of claim 1 further comprising advertising of the device using a beacon channel to negotiate spectrum and specification requirements.

8. The method of claim 1 further comprising elaborating on Medium Access Control (MAC) protocols for coordinating the usage of multiple frequency bands simultaneously.

9. A computer program executed on a processor to perform the method of claim 1.

10. The method of claim 1 wherein the set of spectrum channels comprises at least one of television bands, cellular bands, am radio bands, and fm radio bands.

11. A device capable of simultaneous operations in multiple frequency bands comprising:
a sensor for sensing one or more vacant channels;
a processing module for determining availability of a set of spectrum channels in the one or more vacant channels for broadband communication;
a communication module for reserving one or more particular spectrum channels; and
a configuration module for reprogramming the device for the one or more particular spectrum channels for communication.

12. The device of claim 11, wherein the one or more vacant channels comprises white space spectrum.

13. The device of claim 11, wherein the communication module further reserves the one or more sufficient spectrum channels to avoid other devices occupying the one or more sufficient spectrum channels.

14. The device of claim 11, wherein the device is one of a group comprising: a computing device, a portable computing device, a desktop computer, a laptop computer, a palm sized computer, a pocket-sized computer, a personal computer memory card international association (PCMCIA) card or PC card, a cellular telephone, a personal data assistant (PDA), a personal information manager (PIM), a wireless access point (WAP), a base station, a base station transceiver, a microelectronic circuit, and a circuit board.

15. The device of claim 11 wherein the set of spectrum channels comprises at least one of television bands, cellular bands, am radio bands, and fm radio bands.

16. A device capable of simultaneous operations in multiple frequency bands comprising:
means for sensing one or more vacant channels;
means for determining availability of one or more particular spectrum channels in the one or more vacant channels for broadband communication;
means for reserving the one or more particular spectrum channels; and
means for reprogramming the device for the one or more particular spectrum channels for communication.

17. The device of claim 16, wherein the one or more vacant channels comprises white space spectrum.

18. The device of claim 16 further comprising reserving the one or more particular spectrum channels to avoid other devices occupying the one or more particular spectrum channels.

19. The device of claim 16, wherein the first device and second device are one of a group comprising: a computing device, a portable computing device, a desktop computer, a laptop computer, a palm sized computer, a pocket-sized computer, a personal computer memory card international association (PCMCIA) card or PC card, a cellular telephone, a personal data assistant (PDA), a personal information manager (PIM), a wireless access point (WAP), a base station, a base station transceiver, a microelectronic circuit, and a circuit board.
